(19) United States
(12) Patent Application Publication
(10) Pub. No.: US 2026/0319911 A1
(43) Pub. Date: Oct. 15, 2026

(54) IN-SYSTEM HD VISUAL INSPECTION SYSTEM FOR BACKPLANE CONNECTIONS

(71) Applicant: NVIDIA CORPORATION, Santa Clara, CA (US)

(72) Inventors: Jinshui LIU, Plano, TX (US); Sean Xiong CHEN, Portland, OR (US); John PARK, San Jose, CA (US)

(21) Appl. No.: 19/251,608

(22) Filed: Jun. 26, 2025

Related U.S. Application Data
(60) Provisional application No. 63/786,187, filed on Apr. 9, 2025.

(51) Int. Cl. G06F 11/34; G06F 11/30

(52) U.S. Cl. CPC G06F 11/3485; G06F 11/3041

(57) ABSTRACT

In one embodiment, an inspection system, includes an inspection tray that couples to a slot in a rack or chassis, and a computing device. The inspection tray includes a first universal serial bus (USB) optical sensor having a first field of view that includes a first connector on a backplane of the rack or chassis when the inspection tray is inserted into the slot. The computing device couples to the first USB optical sensor and generates a diagnosis of one or more connectivity disruptions associated with the first connector based on one or more images captured by the first USB optical sensor.

### CROSS-REFERENCE TO RELATED APPLICATIONS

This application claims the benefit of U.S. Provisional Application titled “IN-SYSTEM HD VISUAL INSPECTION SYSTEM FOR BACKPLANE CONNECTIONS,” filed on Apr. 9, 2025, and having Ser. No. 63/786,187. The subject matter of this related application is hereby incorporated herein by reference.

### BACKGROUND

### Field of the Various Embodiments

Embodiments of the present disclosure relate generally to racks used in data centers, artificial intelligence (AI), and cloud computing environments, and, more specifically, to an in-situ backplane inspection system.

A rack designed for a typical data center includes an array of slots capable of accommodating modular compute trays, network trays, storage trays, or the like. Additionally, a backplane interconnects the different slots. The backplane may be a PCB backplane, a cable cartridge, an optical backplane, a midplane, or the like. A tray, also known as a blade, for example, a compute blade, a network blade, or a storage blade, can slide into a given slot in the rack. Connectors on the compute, network, or storage tray engage with connectors on the backplane, providing the tray with networking connections to other trays via the backplane. Connectivity disruptions can occur when a backplane connector sustains damage or contamination. However, diagnosing these disruptions poses challenges because the backplane resides deep within the rack, thereby rendering the connectors generally inaccessible.

The slots in a given rack typically exhibit a very narrow slot pitch, such as 1RU or smaller. These dimensions limit the field of view and make visual inspection of the backplane difficult or impossible. In some instances, one or more adjacent trays must be removed to widen the field of view to better expose the backplane. Any removed trays are re-inserted into the rack once inspection and diagnosis are complete. A drawback of this approach is that removing and subsequently re-inserting trays to facilitate visual inspections can inadvertently damage otherwise functional connectors and expose these connectors to contamination by foreign objects, which can potentially lead to additional connectivity disruptions and slow down the overall inspection process.

If connectivity issues cannot be diagnosed via visual inspection, the backplane often requires complete removal to better expose any potentially damaged connectors. However, the backplane constitutes a large and complex component with significant mechanical and electrical connections, thereby making removal a non-trivial task. In fact, removing the backplane from a rack is a complicated undertaking that usually demands technical skill and a significant amount of time.

As the foregoing illustrates, what is needed in the art is a more effective technique for diagnosing connectivity disruptions in racks during manufacturing or while residing in data centers.

### GENERAL DESCRIPTION

In one embodiment, an inspection system, includes an inspection tray that couples to a slot in a rack or chassis, and a computing device. The inspection tray includes a first universal serial bus (USB) optical sensor having a first field of view that includes a first connector on a backplane of the rack or chassis when the inspection tray is inserted into the slot. The computing device couples to the first USB optical sensor and generates a diagnosis of one or more connectivity disruptions associated with the first connector based on one or more images captured by the first USB optical sensor.

In another embodiment, an inspection tray for diagnosing defective connectors in computer system enclosures includes a first optical sensor having a first field of view that includes a first connector on a computer system enclosure when the inspection tray is inserted into a server slot included in the computer system enclosure, where the inspection tray has a form factor that is physically compatible with the server slot, and an interface that transmits one or more images captured by the first optical sensor to a computing device that generates a diagnosis of one or more connectivity disruptions associated with the first connector based on the one or more images.

In yet another embodiment, a computer-implemented method includes causing a first optical sensor to capture one or more images of a first connector on a rack and executing one or more machine learning algorithms based on the one or more images to generate a diagnosis of one or more connectivity disruptions associated with the first connector.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments;

FIG. 2 is a more detailed illustration of the inspection tray of FIG. 1, according to various embodiments;

FIG. 3 illustrates the inspection tray of FIGS. 1-2, configured to diagnose connectivity disruptions associated with multiple connectors, according to various embodiments;

FIG. 4 is a more detailed illustration of the computing device of FIG. 1, according to various embodiments;

FIG. 5 is a flow chart of method steps for diagnosing connectivity disruptions in racks, according to various embodiments;

FIG. 6 is an exemplary network architecture, according to various embodiments;

FIG. 7 is a more detailed illustration of the network architecture of FIG. 6, according to various embodiments;

FIG. 8 is a more detailed illustration of the data center of FIGS. 6-7, according to various embodiments; and

FIG. 9 is a computing ecosystem for generating machine learning and artificial intelligence models, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

A rack in a typical data center includes an array of slots where modular computer systems can be mounted, as well as a backplane that interconnects the different slots which may have multiple computer switches. During testing or in the field, trays are inserted into the chassis, which has a small pitch such as 1RU or even narrower. This small pitch sometimes causes testing failures due to potential damage or falling particles inside the connectors. Connectivity disruptions can occur when connectors on the backplane become damaged or contaminated. However, these disruptions cannot easily be diagnosed because the backplane resides deep within the rack and the connectors are generally inaccessible. The chassis is roughly 800 mm deep, making it tedious to remove and inspect each tray due to the extensive cabling and the risk of causing additional damage during re-insertion. Conventional diagnostic techniques are technically complex and time consuming and often involve manually disassembling the rack to access the backplane. In the field, if a test fails, it is challenging to inspect the backplane connectors for damage or falling particles without removing the trays. This process is complicated and time-consuming, and re-inserting the trays can cause further issues.

To address these issues, an inspection tray includes optical sensors that are positioned to capture images of backplane connectors when the inspection tray is inserted into a slot in a rack currently under test. In some embodiments, the inspection tray further includes optical emitters, such as light-emitting diodes (LED), that illuminate the backplane connectors. The optical sensors are coupled to a hub that can be accessed by a client computing device. The client computing device is configured to output images and/or video of the backplane connectors via a display device, allowing a technician to manually inspect and/or diagnose connectivity issues. The client computing device is also configured to execute an inspection application that analyzes the images and/or video of the backplane connectors and implements machine learning algorithms to automatically identify various types of conditions that can cause connectivity disruptions. The inspection tray generally has a form factor that is compatible with different types of slots included in various racks. The position and alignment of the optical sensors and/or images captured by those sensors can be modified in order to facilitate the inspection of different types of backplanes having different connector configurations.

The disclosed techniques enable backplane connectors in racks that reside in a data center environment to be evaluated to diagnose connectivity issues without needing to embark on the technically complex task of disassembling the rack to remove the backplane. These techniques can be applied to facilitate the manual inspection of backplane connectors and/or to support automatic diagnosis of connectivity disruptions performed via machine learning models and/or artificial intelligence. In the manual inspection, the inspection tray is used when a problem is detected in a specific slot. The suspect tray is removed, and the inspection tray is inserted into the slot to inspect the backplane connectors without making contact, ensuring a clear image for manual inspection.

### System Overview

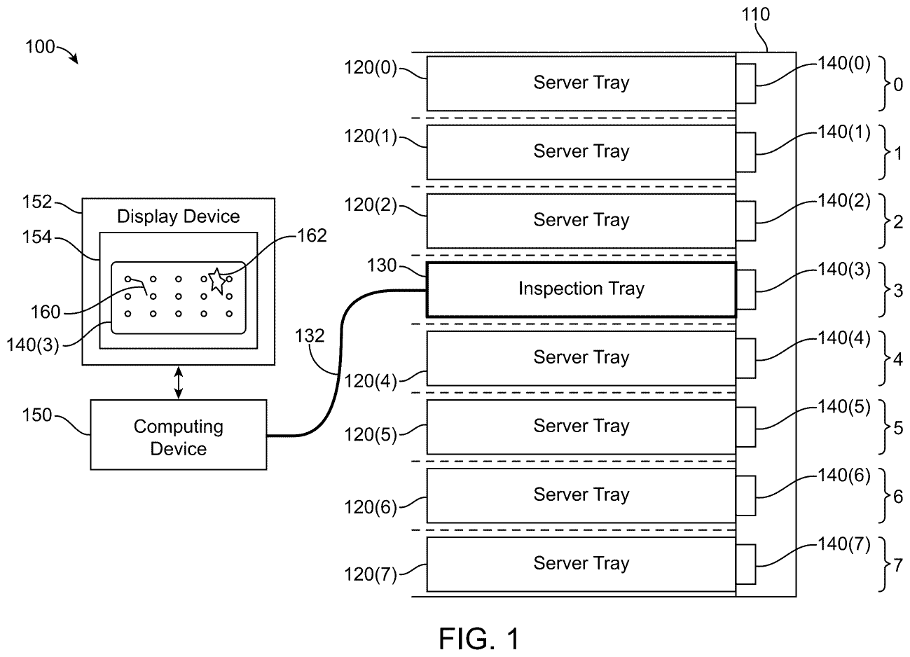

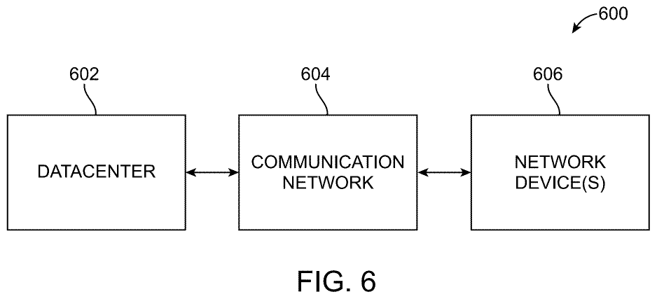

FIG. 1 illustrates a system configured to implement one or more aspects of the various embodiments. As shown, a rack 100 includes a backplane 110 that is coupled with one or more server trays 120. The rack 100 also includes an inspection tray 130 that is coupled to a computing device 150. The rack 100 can be any technically feasible type of enclosure that is configured to store modular computer systems, including a network cabinet, server cabinet, or a chassis, for example and without limitation. The backplane 110 can be any technically feasible type of interconnect, including a printed circuit board assembly (PCBA) backplane or a cable cartridge backplane, for example and without limitation. A given server tray can be any technically feasible type of computer system that is mounted to, or integrated with, a casing of some form that allows the server tray 120 to be inserted into and extracted from the rack 100. For example, and without limitation, a given server tray 120 could be a blade or a node, among others. Further, any given server tray 120 can be a compute tray that provides computing resources, a network tray that provides networking resources, a storage tray that provides storage resources, and so on. Rack 100 generally resides in a data center or other cloud computing environment. In various embodiments, rack 100 may reside within a data center described in greater detail below in conjunction with FIGS. 6-9.

Backplane 110 is divided into slots 0 through 7. Each slot includes one or more connectors 140. In particular, slots 0 through 7 include connectors 140(0) through 140(7), respectively. A given connector 140 can be any technically feasible type of connector configured to conduct electricity and/or transmit data. For example, a given connector 140 could include a plurality of conductive pins and/or a plurality of conductive sockets. Server trays 120(0) though 120(2) occupy slots 0 through 2, respectively, and are configured to be coupled to backplane 110 via connectors 140(0) through 140(2), respectively. Inspection tray 130 occupies slot 3 and operates in a manner described in greater detail below. Server trays 120(4) through 120(7) occupy slots 4 through 7, respectively, and are configured to be coupled to backplane 110 via connectors 140(4) through 140(7), respectively. In the configuration shown, backplane 110 can distribute various resources to server trays 120, including, for example and without limitation, power resources, cooling resources, and/or networking resources, among others. Further, server trays 120 are configured to interoperate with one another via the interconnections provided by backplane 110.

Inspection tray 130 is a diagnostic instrument that is configured to facilitate the evaluation of connectivity disruptions associated with the various connectors included in the rack 100. In the exemplary configuration shown, inspection tray 130 occupies slot 3 to facilitate the evaluation of connectivity disruptions associated with connector 140(3). In particular, inspection tray 130 captures various types of sensor data relative to connector 140(3) and transmits that sensor data to computing device 150 via cable 132. In various embodiments, inspection tray 130 may alternatively communicate with computing device 150 wirelessly. Computing device 150 then displays images and/or video derived from the received sensor data via display device 152. In the example shown, display device 152 displays an image 154 of connector 140(3) that depicts a broken pin 160 and a foreign object 162, either or both of which could be responsible for the connectivity disruptions associated with connector 140(3).

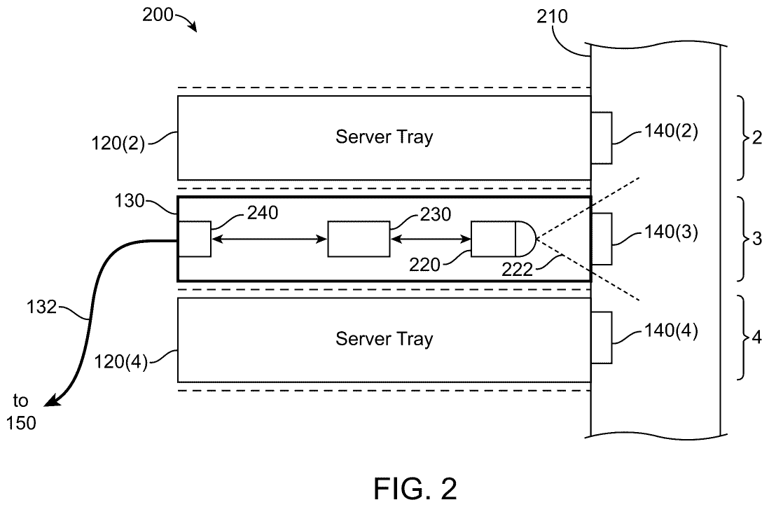

Computing device 150 is configured to perform an analysis on the sensor data received from inspection tray 130 using one or more machine learning algorithms to determine potential causes of the connectivity disruptions. For example, and without limitation, computing device 150 could execute a machine learning algorithm configured to identify broken pins on connectors 140, and then identify broken pin 160. Similarly, computing device 150 could execute a machine learning algorithm to identify foreign objects resident in connectors 140, and then identify foreign object 162. Persons skilled in the art will understand that computing device 150 can execute any technically feasible type of machine learning algorithm to identify any technically feasible type of condition that may disrupt connectivity in electrical connectors. Based on the results of the analysis, computing device 150 generates a connectivity diagnosis that describes the potential causes of the connectivity disruption. The connectivity diagnosis can identify, for example, locations of defective pins, foreign objects, etc., provide descriptions of the defective pins, foreign objects, etc., and so on. The configuration and operation of inspection tray 130 and computing device 150 are described in greater detail below in conjunction with FIGS. 2-5.

### In-Situ Backplane Inspection

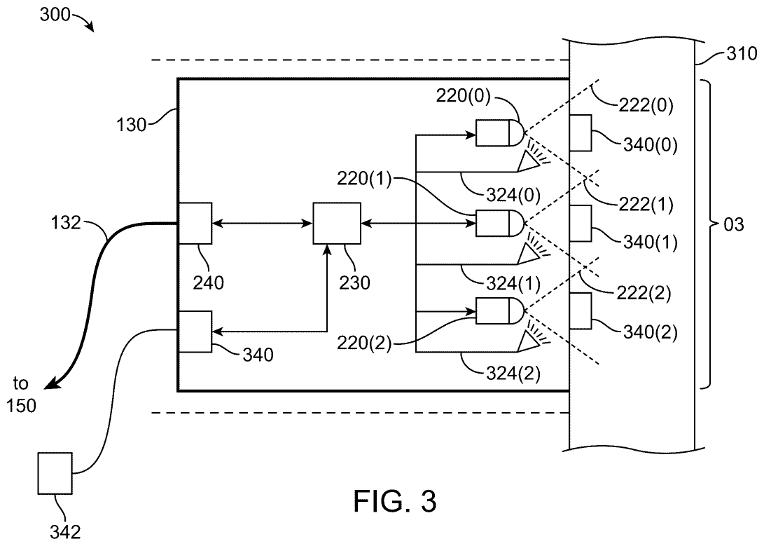

FIG. 2 is a more detailed illustration of the inspection tray of FIG. 1, according to various embodiments. As shown, a portion 200 of the rack 100 of FIG. 1 includes a portion 210 of the backplane 110 of FIG. 1. Portion 200 includes server trays 120(2) and 120(4) mounted in slots 2 and 4, respectively, and coupled to connectors 140(2) and 140(4), respectively, as also shown in FIG. 1. Inspection tray 130 occupies slot 3 and includes an optical sensor 220, a hub 230, and an interface 240. Optical sensor 220 captures sensor data associated with objects that reside within field of view 222, including image and/or video data. The optical sensor 220 may be adjustable cameras to ensure the best focus and clear images of the connectors. Optical sensor 220 could be, for example and without limitation, a high-definition (HD) video camera, a photodiode, a CCD, a CMOS sensor, a phototransistor, Position-Sensitive Detectors (PSDs,) Photomultiplier Tubes (PMTs). In some embodiments, the inspection tray 130 further includes optical emitters, such as LEDs, for example and without limitation, configured to illuminate objects that reside within field of view 222. Such optical emitters may be adjustable in order to selectively illuminate different areas of interest. In the example shown, optical sensor 220 captures images and/or video data of connector 140(3). The system is optimized for connector visibility and can capture images from multiple connectors simultaneously. The optical sensor 220 is strategically positioned on the inspection tray, enhancing image quality and operational efficiency. Optical sensor 220 transmits the captured sensor data to hub 230. Hub 230 could be, for example and without limitation, a universal serial bus (USB) hub. In various embodiments, hub 230 may receive sensor data from multiple optical sensors, as described in greater detail below in conjunction with FIG. 3. Hub 230 transmits the received sensor data to interface 240. Interface 240 could be, for example and without limitation, a USB interface. Computing device 150 receives the sensor data via cable 132 coupled to interface 140. In various embodiments, inspection tray 130 may communicate with computing device 150 via a wireless communication channel.

Inspection tray 130 generally has a physical form factor that is compatible with any of slots 0 through 7, allowing inspection tray 130 to be easily inserted into and removed from the rack 100. Optical sensor 220 is positioned within inspection tray 130 such that field of view 222 generally includes one or more connectors 140 that need to be inspected, such as connector 140(3), thereby facilitating the capture of highly detailed images and/or video data. In various embodiments, optical sensor 220 is configured to pan and/or zoom in order to gather additional sensor data pertaining to specific regions of interest. Such functionality can be accomplished through optical adjustments within optical sensor 220, mechanical adjustments implemented by optical sensor 220, via downstream image processing on computing device 150, and so on. Similar mechanical techniques can be applied to adjust an area of illumination associated with an optical emitter, such as an LED, configured to illuminate various regions of interest. In the configuration shown in FIG. 2, inspection tray 130 facilitates the collection of sensor data associated with connector 140(3) without needing any adjacent trays to be removed.

In various embodiments, the components of inspection tray 130 can be integrated into a given server tray 120 along with compute and/or networking components associated with a computer system, thereby facilitating the inspection of connectors 140 associated with a given slot while the server tray 120 resides in that slot. In various other embodiments, optical sensor 220 within inspection tray 130 can be configured to capture sensor data associated with connectors 140 in adjacent slots without needing the adjacent server trays 120 to be removed.

FIG. 3 illustrates the inspection tray of FIGS. 1-2 configured to diagnose connectivity disruptions associated with multiple connectors, according to various embodiments. As shown, a portion 300 of the rack 100 of FIG. 1 includes a portion 310 of the backplane 110 of FIG. 1. Inspection tray 130 resides in slot 3 and includes additional optical sensors 220 positioned to align with multiple different connectors 340 and optical emitters 324 configured to illuminate connectors 340. In particular, optical sensor 220(0) is aligned with connector 340(0) and is configured to capture sensor data associated with connector 340(0) from within field of view 222(0). Optical emitter 324(0) is configured to illuminate connector 240(0). Optical sensor 220(1) is aligned with connector 340(1) and is configured to capture sensor data associated with connector 340(1) from within field of view 222(1). Optical emitter 324(1) is configured to illuminate connector 240(1). Optical sensor 220(2) is aligned with connector 340(2) and is configured to capture sensor data associated with connector 340(2) from within field of view 222(2). Optical emitter 324(2) is configured to illuminate connector 240(2). Hub 230 is coupled to each of optical sensors 220 and optical emitters 324 and is configured to receive the sensor data captured by the optical sensors 220 for transmission to computing device 150 via interface 240 and cable 132. Optical sensors 220 and optical emitters 324 are also coupled to a power connector 340 via hub 230 that, in turn, is coupled to a power source 342. Power source 342 may be an alternative current (AC) power source or a direct current (DC) power source. In various embodiments, the position, orientation, and/or brightness of optical emitters 324 can be automatically adjusted via commands from computing device 150 in order to illuminate connectors 240 and provide optical sensors 220 with a clear picture. Any of optical sensors 240, optical emitters 324, or hub 230 may be compatible with universal serial bus (USB) interface technology, in various embodiments. The configuration shown in FIG. 3 allows inspection tray 130 to facilitate the evaluation of connectivity disruptions associated with multiple different connectors 340 included in a particular slot of backplane 110.

In various embodiments, inspection tray 130 includes mechanisms that permit the position and orientation of a given field of view 222 to be modified during evaluation of connectors 340. For example, and without limitation, inspection tray 130 could include servomechanisms that physically reposition and/or re-orient optical sensors 220. Alternatively, and without limitation, optical sensors 220 could implement digital panning and/or digital zooming functionality in order to capture more detailed sensor data from specific regions of interest. Persons skilled in the art will understand how the configuration of optical sensors 220 within inspection tray 130 can be modified dynamically in order to facilitate the evaluation of connectivity disruptions.

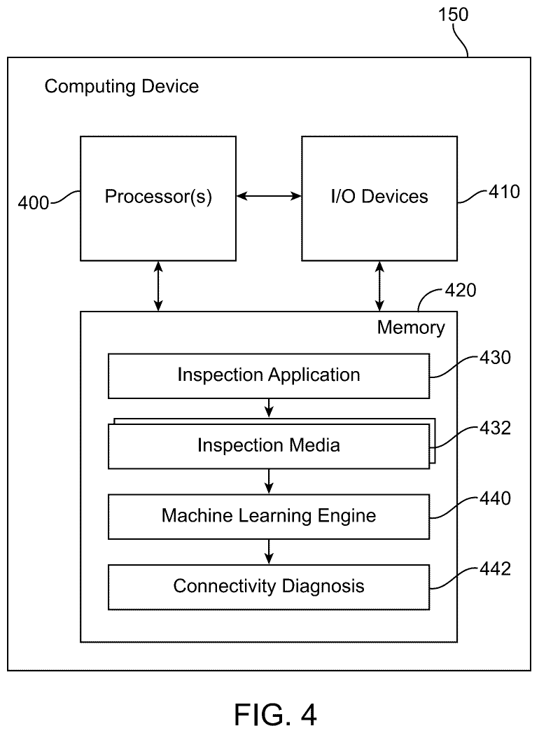

FIG. 4 is a more detailed illustration of the computing device of FIG. 1, according to various embodiments. As shown, the computing device 150 includes one or more processor(s) 400, input/output (I/O) devices 410, and memory 420, coupled together. As a general matter, computing device 150 could be any technically feasible type of computer system, including a laptop computer, a desktop computer, a handheld computing device, and so forth, for example and without limitation.

Processor(s) 400 may include one or more central processing units (CPUs), graphics processing units (GPUs), quantum processing units (QPUs), parallel processing units (PPUs), application specific integrated circuits (ASICs), field programmable gate arrays (FPGAs), and/or any other technically feasible type of electronic construct configured to process data. QPUs are processors configured to perform one or more operations associated with a quantum algorithm. In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

I/O devices 410 may include input devices, such as a keyboard or mouse, without limitation, output devices, such as display devices or acoustic devices, without limitation, and/or devices configured to both receive input and generate output, such as a touchscreen, without limitation. Memory 420 may include one or more random access memory (RAM) modules, one or more hard disks, one or more read-only memory (ROM) modules, or any other technically feasible type of storage construct configured to store data and/or software applications.

Memory 430 includes inspection application 430, inspection media 432, machine learning engine 440, and connectivity diagnosis 442. Inspection application 430 is a software application that, when executed by processor(s) 400, gathers sensor data from optical sensors included in inspection tray 130 and displays images and/or video derived from that sensor data via display device 152. In addition, inspection application 430 stores some or all of that data as inspection media 432. Inspection media 432 generally includes any technically feasible type of sensor data captured by any technically feasible type of sensor, including the images and/or video data discussed thus far.

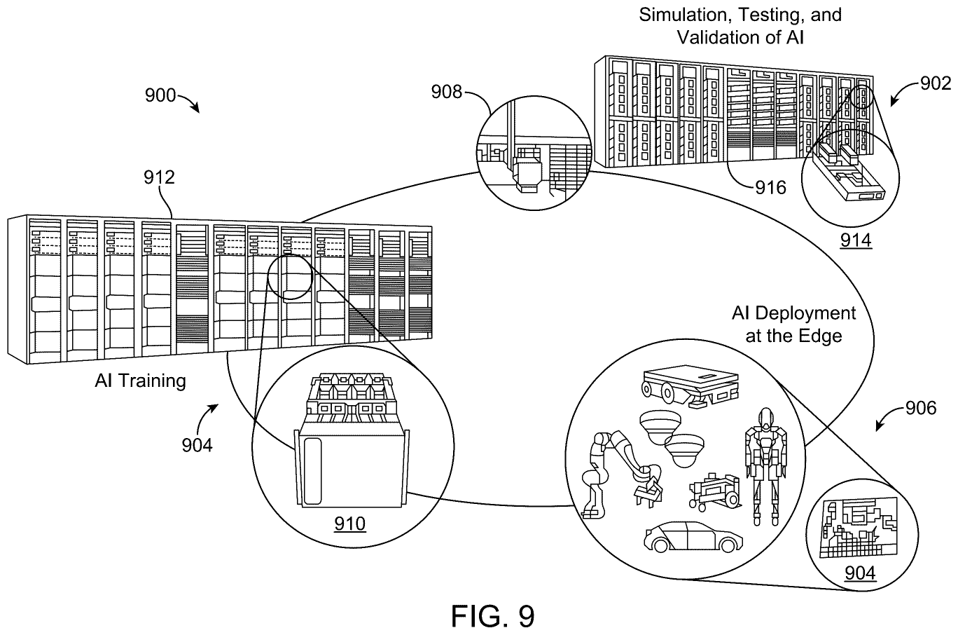

Machine learning engine 440 implements one or more machine learning algorithms based on inspection media 432 in order to identify potential causes of connectivity disruptions associated with connectors included in rack 100. In various embodiments, machine learning engine 440 may include one or more computer vision algorithms that identify specific sources of disruption, such as broken pin 160 or foreign object 162 shown in FIG. 1. In various other embodiments, machine learning engine 442 implements one or more machine learning models, such as, for example and without limitation, visual-language models (VLMs), in order to generate language describing the appearance of a given connector depicted in inspection media 432, including any observed damage or aberrations. In various embodiments, one or more machine learning models implemented by machine learning engine 440 may be trained via the computing ecosystem described below in conjunction with FIG. 9. Machine learning engine 440 generates connectivity diagnosis 442 to describe the various potential causes of the connectivity disruption(s). Connectivity diagnosis 442 may include text, images, or any other technically feasible form of media that describes and/or depicts those potential causes.

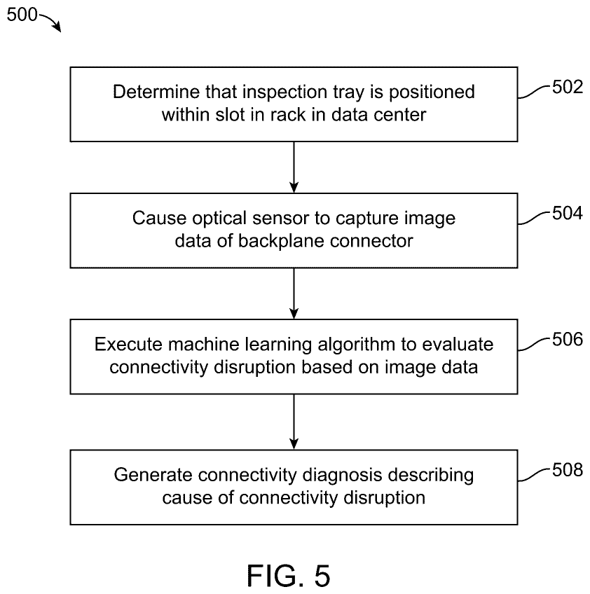

FIG. 5 is a flow chart of method steps for diagnosing connectivity disruptions in racks, according to various embodiments. Although the method steps are described in conjunction with the systems of FIGS. 1-4, persons skilled in the art will understand that any system configured to perform the method steps, in any order, is within the scope of the present embodiments.

As shown, a method 500 begins at step 502, where the inspection application 430 determines that the inspection tray 130 is positioned within a slot in the rack 100. For example, and without limitation, the inspection application 430 could analyze images and/or video data captured via optical sensor(s) 220 to determine that the inspection tray 130 is inserted into a slot. The rack 100 generally resides in a data center or other cloud computing environment.

At step 504, the inspection application 430 causes optical sensor(s) 220 to capture image and/or video data associated with one or more connectors 140 or 240. In so doing, inspection application 430 may cause optical sensor(s) 220 to physically reposition and/or re-orient, or digitally pan and/or zoom, in order to shift focus to a specific portion of a given connector and/or a different connector. Inspection application 430 stores the image and/or video data in inspection media 432.

At step 506, machine learning engine 440 executes one or more machine learning algorithms based on inspection media 432 to identify potential causes of connectivity disruptions associated with the connectors under evaluation. Machine learning engine 440 may implement one or more computer vision algorithms that identify specific sources of disruption, such as broken pin 160 or foreign object 162 shown in FIG. 1, for example and without limitation. In various other embodiments, machine learning engine 442 implements one or more trained machine learning models to generate language describing the appearance and/or condition of a given connector 140 or 340 depicted in inspection media 432, including any potential aberrations.

At step 508, machine learning engine 440 generates connectivity diagnosis 442 to describe the various potential causes of the connectivity disruption(s). Connectivity diagnosis 442 may include text, images, videos, or any other technically feasible form of media that describes and/or depicts those potential causes.

In sum, an inspection tray includes one or more optical sensors that are positioned to capture images of one or more backplane connectors when the inspection tray is inserted into a slot in a rack. The optical sensors are coupled to a hub that can be accessed by a client computing device. The client computing device can display images and/or video of the backplane connectors via a display device, thereby facilitating visual inspection of the backplane connectors and/or diagnosis of connectivity disruptions. The client computing device is also configured to execute an inspection application that analyzes one or more images of the backplane connector(s) and implements one or more machine learning algorithms by integrating AI-based image recognition software to automatically identify various types of conditions that can adversely affect connectivity between the backplane and any computer systems coupled thereto. The inspection tray generally has a form factor that is compatible with one or more different types of slots included in various racks. The position and alignment of the optical sensors and/or images captured by those sensors can be modified in order to facilitate the inspection of different types of backplanes having different connector configurations.

The disclosed techniques enable backplane connectors in racks to be automatically evaluated to diagnose connectivity issues without needing to remove any adjacent trays. Accordingly, removing and reinserting adjacent trays can be avoided, saving time and preventing potential damage. Connectivity disruptions can be effectively diagnosed without needing to embark on the technically complex task of removing the backplane. The techniques disclosed herein can be implemented in a wide variety of different computing environments, including data centers, as discussed above.

Data centers and other networking systems may include connections between data centers, switch systems, servers, racks, and devices in order to provide for signal transmission between one or more of these elements. These connections may be made using cables, transceivers, interconnects, interposers, and connector assemblies. For high bandwidth applications and/or connections over long distances, high powered optical communications may be preferred to ensure signal transmission integrity.

Data centers may include multiple network switches in a particular topology, such as a fat tree topology, a slim fly topology, a dragonfly topology, multi-level fat-trees, fat-flys, Benes, Clos, meshes, and tori and/or the like. The specifications and makeup of the network switches in the topology affects the overall network performance (e.g., bandwidth capability) of the data center.

Data centers are the storage and data processing hubs of the internet. The massive deployment of cloud applications is causing data centers to expand exponentially in size, stimulating the development of faster switches than can cope with the increasing data traffic inside the data center. Current state-of-the-art switches are capable of handling 12.8 Tb/s of traffic by employing electrical switches in the form of application specific integrated circuits (ASICs) equipped with 256 data lanes, each operating at 50 Gb/s. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

### Example Data Center Environment

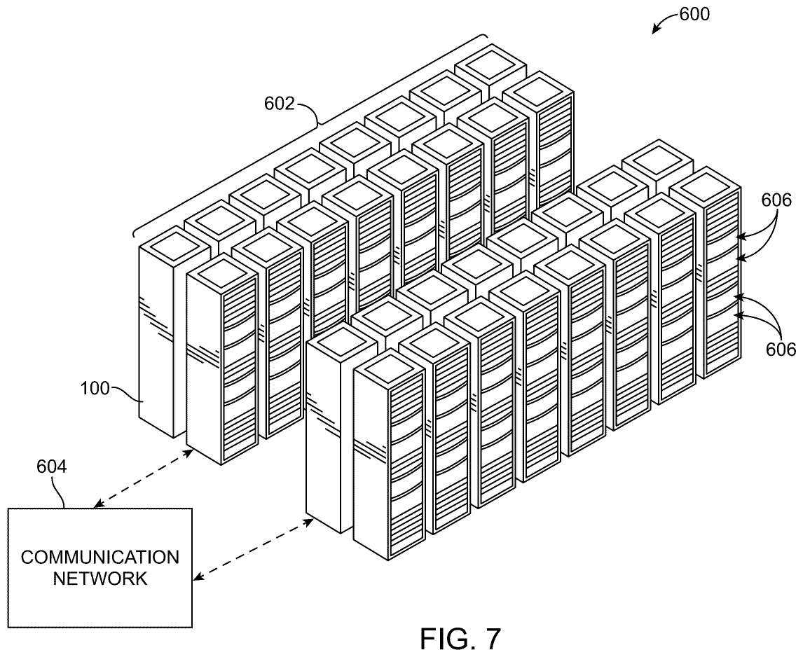

As described above, data centers, high performance computing clusters, and/or the like are often formed of various computing components or networked devices, and communication networks formed of electrical and/or optical devices may be used to enable communication between the networked devices forming these implementations. With reference to FIGS. 6-7, for example and without limitation, a network architecture 600 may include a data center 602, a communication network 604, and one or more network device(s) 606. In various embodiments, the data center 602 includes an instance of the rack 100 of FIG. 1, configured to include the inspection tray 130 coupled to the computing device 150, as also shown in FIG. 1. The network architecture 600 may illustrate a general computing architecture within which more specific systems and/or subsystems may function. Although described hereinafter with reference to a network architecture 600 and/or data center 602 within which embodiments of the present disclosure may be implemented, the present disclosure contemplates that the various techniques described herein may be applicable to any network architecture, without limitation.

The data center 602 may be a centralized facility designed to house computing resources and related components. The data center 602 may operate to support the infrastructure required for advanced computational tasks, for efficient, secure, and reliable operations. The data center 602 may include the building and structural components, including power supplies, cooling systems, fire suppression systems, and physical security measures that are configured to maintain optimal operating conditions and/or protect the equipment from environmental hazards and unauthorized access. An example data center 602 may include high-performance servers or compute nodes, often arranged in racks, such as those illustrated in FIG. 7, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

In various embodiments, the data center 602 corresponds to a collection of network devices and may include various high-speed network equipment, such as network switches (e.g., Ethernet switches, IP routers, multiservice platforms, various transmission network elements, legacy communication equipment, or in any other suitable communication system), routers, firewalls, and/or the like to facilitate fast and secure data transmission within the data center 602 (e.g., between servers or compute nodes) and between external networks. The data center 602 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the data center 602 may support high-performance computing tasks. Examples of various network topologies may include hierarchical networking topologies such as the fat tree topology, Slim Fly topology, Dragonfly topology, and/or the like, as also mentioned above.

The communication network 604 may communicably couple the data center 602 with network device(s) 606 and other external devices for data exchange and connectivity. Examples of the communication network 604 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 604 to incorporate multiple network types and configurations may allow the data center 602 to adapt to diverse application needs, from general data communication to specialized HPC tasks. As described herein, the communication network 604 may leverage various optical components to establish communication links (e.g., communicably couple) between components in the network architecture 600. As such, the communication network 604 may include various optical devices, transceivers, modules, and/or the like that are configured to generate optical signals (e.g., provide optical transmitter functionality) and/or receive optical signals (e.g., provide optical receiver functionality) via optical fibers or other optical communication media in order to establish connection between various devices in the network architecture 600. In one specific but non-limiting example, the communication network 604 is a network that enables data transmission between network devices 608 using data signals (e.g., digital, optical, wireless signals).

The network device(s) 606 may include a variety of computing devices capable of transmitting and receiving signals over the communication network 604. The network device(s) 606 may range from personal computing devices to complex server configurations. Examples include Personal Computers (PCs), laptops, tablets, smartphones, or one or more servers. The network device(s) 606 may facilitate user interactions with the data center 602, allowing for data input, retrieval, and processing from remote locations. In addition to individual computing devices, the network device(s) 606 may also include collections of servers or additional data centers. For instance, these could be other data centers similar to or the same as data center 602. Such an interconnection may allow for the formation of a distributed computing environment for improved redundancy, load balancing, and disaster recovery capabilities. By linking multiple data centers, the network architecture 600 may leverage geographically dispersed resources, optimizing performance and ensuring high availability.

As described herein, the data center 602 and/or the network device(s) 606 may include storage devices and processing circuitry for executing computing tasks, such as controlling the flow of data internally and over the communication network 604. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that the data center 602 and network device(s) 606 may include one or more communication interfaces for facilitating wired and/or wireless communication between one another and other unillustrated elements of the network architecture 600. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 600.

Furthermore, the present disclosure contemplates that the network architecture 600 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 600 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 600.

In various embodiments, a switch fabric serves to transfer data between switch ports included in the network architecture 600 and/or one or more data centers 602. A switch fabric comprises one or more interconnect circuits, which may be arranged in various switch fabric architectures, e.g., m*m crossbar, Banyan, Benes, Omega, Clos, multi-plane, STS, TST, shared memory, buffered crossbar, any other suitable blocking or non-blocking architecture, or any applicable mixed architecture thereof. A switch fabric is realized in typical embodiments by hardware, which may comprise Field-Programmable Gate Arrays (FPGAs) and/or Application-Specific Integrated Circuits (ASICs), and in some implementations also bus interconnects. The data center 602 routes traffic amongst the network switches and servers therein, and at least one layer of the topology in the data center 602 is coupled to the communication network 604 to allow networking traffic to flow between the data center 602 and the network device(s) 606.

As discussed above, the communication network 604 can be implemented using various types of networks and/or combinations of different types of networks. Each type of network offers specific advantages tailored to different operational requirements. For instance, an IP network or Ethernet network may provide widespread compatibility and ease of integration, supporting various protocols and applications across the data center 602 and the network device(s) 606 (and/or external devices). An InfiniBand network may offer high throughput and low latency, ideal for HPC environments where rapid data transfer and minimal delay are required. Fibre Channel networks may be employed for their robust performance in storage area networks (SANs), ensuring fast and reliable access to storage resources. Cellular and wireless communication networks may be used to extend connectivity to remote or mobile devices for increased flexibility and accessibility.

In various embodiments, the network device(s) 606 may include a variety of computing devices capable of sending and receiving signals over the communication network 604. The network device(s) 606 can range from personal computing devices to complex server configurations. Examples include Personal Computers (PCs), laptops, tablets, smartphones, or one or more servers, as mentioned. In at least one example embodiment, the one or more network devices 606 correspond to another data center, similar to or the same as data center 602. The network device(s) 606 may facilitate user interactions with the data center 602, allowing for data input, retrieval, and processing from remote locations. In addition to individual computing devices, the network device(s) 606 may also include collections of servers or additional data centers. For instance, these could be other data centers similar to or the same as data center 602. Such an interconnection may allow for the formation of a distributed computing environment for improved redundancy, load balancing, and disaster recovery capabilities. By linking multiple data centers, the network architecture 600 can leverage geographically dispersed resources, optimizing performance and ensuring high availability.

The data center 602 and/or the network device(s) 606 may include storage devices and/or processing circuitry for carrying out computing tasks, for example, and without limitation, tasks associated with controlling the flow of data internally and/or over the communication network 604. Such processing circuitry may comprise software, hardware, or a combination thereof. For example, and without limitation, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry may comprise hardware, such as an application specific integrated circuit (ASIC). Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the data center 602 and network device(s) 606 may include one or more communication interfaces for facilitating wired and/or wireless communication between one another and other unillustrated elements of the network architecture 600. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 600. Furthermore, it should be understood that the network architecture 600 may include additional components and functionalities within the scope of the present disclosure.

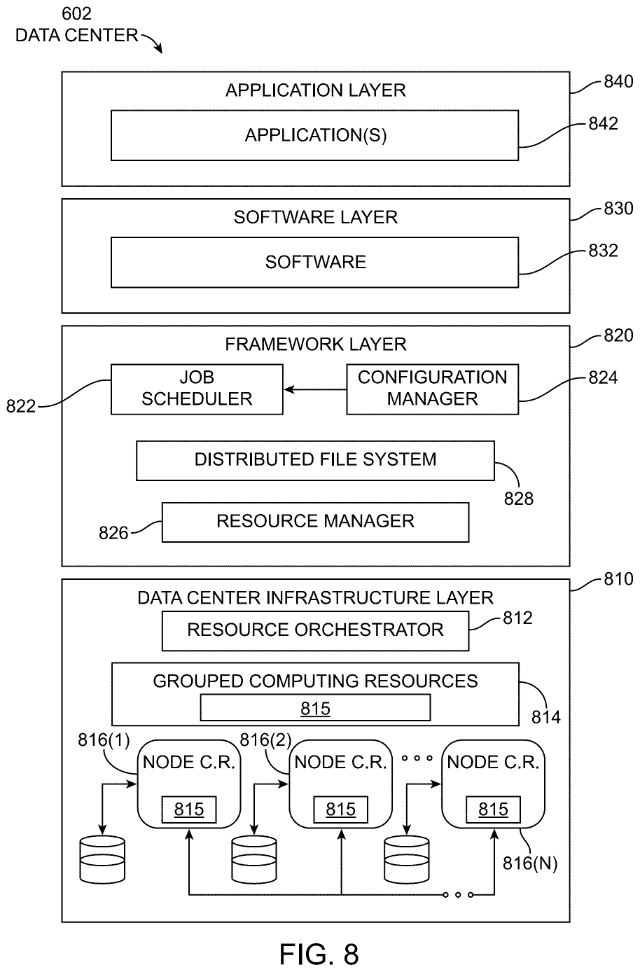

FIG. 8 illustrates an example data center 602, in which at least one embodiment may be used. In at least one embodiment, data center 602 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R. s”) 816(1)-816(N), where “N” represents a positive integer (which may be a different integer “N” than used in other figures). In at least one embodiment, node C.R.s 816(1)-816(N) may include, but are not limited to, any number of central processing units (“CPUs”) or other processors (including accelerators, field programmable gate arrays (FPGAs), graphics processors, etc.), memory storage devices 818(1)-818(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). In at least one embodiment, separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 602. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 602. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resources 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. In at least one embodiment, one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 602 from making possibly bad configuration decisions and possibly avoiding underused and/or poor performing portions of a data center.

In at least one embodiment, data center 602 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 602. In at least one embodiment, trained machine learning models corresponding to one or more neural networks may be used to infer or predict information using resources described above with respect to data center 602 by using weight parameters calculated through one or more training techniques described herein. An exemplary computing ecosystem for generating, training, and deploying AI is described below in conjunction with FIG. 9.

### Computing Ecosystem for Generating, Training, and Deploying AI

FIG. 9 is a system diagram illustrating a three-computer ecosystem 900, including a first computing system 902 for generating or creating artificial intelligence (AI)—such as AI training and validation data, a second computing system 904 for training artificial intelligence, and a third computing system 906 (which may include or correspond to a system on Chip) deploying the AI at the edge, in accordance with at least some embodiments of the present disclosure. For example, to develop and deploy embodied or physical AI, the three-computer ecosystem 900 may be used, including three accelerated computer systems to handle physical AI training, simulation, and runtime (e.g., edge deployment). These systems may generate training data for and train multimodal foundation models (and/or other model types) using scalable, physically based simulations of the machine(s) and their worlds. By doing so, simulation of physical or virtual machine(s) may be performed at scale, allowing for refinement, testing, and optimization of skills (e.g., robot skills) in a virtual world (e.g., using NVIDIA's OMNIVERSE) that mimics the laws of physics-helping to reduce real-world data acquisition costs and ensuring the machine(s) can perform safely in controlled settings.

The computing system 904 (e.g., NVIDIA's DGX Platform) may be used to train and fine-tune powerful foundation and generative AI models. Models, such as general purpose foundation models (e.g., NVIDIA's Project GR00T), may be used to enable robots and other machine(s) to understand natural language and emulate movements by observing human actions. The computing system 904 may include a platform that incorporates software, infrastructure, and expertise in a modern, unified AI development and training solution. The computing system 904 may include individual computing devices 910 (e.g., NVIDIA's DGX B200, H200, etc.) and/or any number of computing devices 910 in a data center infrastructure 912 (e.g., NVIDIA's DGX SuperPOD).

For example, the individual computing devices 910 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 910 may include memory (e.g., 4 TB memory, and storage (e.g., OS storage of 2×1.9 TB NVMe M.2, and internal storage of 8×3.84 TB NVMe U.2). The computing devices 910 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 910 may further include, e.g., dual port quad small form-factor pluggable (QSFFP) data processing units (DPUs) (e.g., 2 dual-port QSFP112 DPUs such as NVIDIA's BlueField-3 DPUs), providing up to 400 Gb/s InfiniBand/Ethernet. The computing device(s) 910 may include an onboard network interface controller (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 910 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 910 may include a smart host channel adapter (HCA) (e.g., NVIDIA's ConnectX-7) to provide ultra-low latency, 400 Gb/s throughput for in-network computing acceleration engines.

The data center infrastructure 912 may include any number of the computing devices 910, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 910) to thousands, job scheduling and orchestration to ensure hassle-free execution of every developer's job, AI workflow management and machine learning operations (MLOps) to move more models from prototype to production, and enterprise software to speed developer success.

The computing system 902 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Lab, etc.). The computing system 902 allows developers to use simulation frameworks to simulate and validate robot models, and/or to generate massive amounts of physically-based synthetic data to bootstrap model training. The computing system 902 may support learning frameworks that power robot reinforcement learning and imitation learning, to accelerate robot policy training and refinement. For example, the computing system 902 may be used to generate any number of simulations 908—such as within NVIDIA's OMNIVERSE. The computing system 902 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 902 may host or support a native OpenUSD software platform enabling enterprises to connect 3D pipelines and develop advanced, real-time 3D applications for industrial digitalization. With powerful ray-tracing-accelerated AI and graphics capabilities, the computing system 902 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 902 may include individual computing devices 914 (e.g., NVIDIA's OVX L40S Server) and/or any number of computing devices 914 in a data center infrastructure 916 (e.g., NVIDIA's OVX Systems).

The computing device(s) 914 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen 4×16:64 GB/s bidirectional interconnect interface, 18,176 CUDA cores, 142 ray tracing (RT) cores, and 568 tensor cores). The computing devices 914 may include various networking and network management components, such as smart host channel adapters (HCA) (e.g., 2or 4 single port ConnextX-7 at 200 Gb/s each, providing up to 800 Gb/s Infiniband/Ethernet), one or more DPUs (e.g., a dual-port QSFP112 DPUs-such as an NVIDIA BlueField-3 DPU), providing up to 400 Gb/s InfiniBand/Ethernet. In some embodiments, the NICs used for the computing device(s) 914 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 914 may include a smart host channel adapter (HCA) (e.g., NVIDIA's ConnectX-7) to provide ultra-low latency, 400 Gb/s throughput for in-network computing acceleration engines. The computing device(s) 914 may include a host memory (e.g., 384 Gb DDR 5 ECC for 4 GPUs, or 768 Gb DDR 5 ECC for 8 GPUs), and may include a dual in-line memory module (DIMM) slot(s), a host boot drive (e.g., 1 TB NVMe), and/or a host storage (e.g., 2 4TB NVMe).

Similar to the data center infrastructure 912, the data center infrastructure 916 may allow for any number of computing device(s) 914 to be combined in cluster configuration according to a reference architecture.

The computing system 906 may be used to deploy trained AI models on a runtime computer—such as a system-on-chip. For example, these computing systems 906 may be designed for compact, on-board computing needs, including an ensemble of models for control policy, vision and language models, etc., deployed on a power-efficient on-board edge computing system 906.

In various embodiments, any element of the three-computer-ecosystem 900 may be implemented via any component described in conjunction with FIGS. 6-8. Further, the three-computer ecosystem 900 may reside within the network architecture 600 or overlap at least a portion of the network architecture 600. For example, and without limitation, the data center infrastructure 912 may be implemented via one or more data centers 602, while the computing system 904 may be implemented via one or more network devices 606. In addition, in various embodiments, elements of the three-computer ecosystem 900 may be used to train the inspection application 430 of FIG. 4 to generate the connectivity diagnosis 442. Persons skilled in the art will understand that the three-computer ecosystem 900 represents just one possible implementation of the network architecture 600.
1. An inspection system, comprising an inspection tray that couples to a slot in a rack or chassis, including a first universal serial bus (USB) optical sensor having a first field of view that includes a first connector on a backplane of the rack or chassis when the inspection tray is inserted into the slot, and a computing device that couples to the first USB optical sensor and generates a diagnosis of one or more connectivity disruptions associated with the first connector based on one or more images captured by the first USB optical sensor.
2. The inspection system of clause 1, further comprising a second USB optical sensor having a second field of view that includes a second connector on the backplane of the rack or chassis when the inspection tray is inserted into the slot.
3. The inspection system of any of clauses 1-2, further comprising one or more USB light-emitting diode (LED) lights, wherein at least one of a position, an orientation, or a brightness associated with the one or more USB LED lights is adjustable to increase an illumination level associated with the first or second connectors on the backplane of the rack or chassis when the inspection tray is inserted into the slot.
4. The inspection system of any of clauses 1-3, further comprising a USB hub that couples the first USB optical sensor to the computing device, wherein the USB hub receives the one or more images from the first USB optical sensor and transmits the one or more images to the computing device, and wherein the one or more USB LED lights are also attached to the USB hub for power and for brightness control from the computing device.
5. The inspection system of any of clauses 1-4, wherein the USB hub is also connected to an external power source to provide power to the first USB optical sensor, the second USB optical sensor, and the one or more USB LED lights.
6. The inspection system of any of clauses 1-5, wherein mounting locations and angles of the first USB optical sensor and the second USB optical sensor are adjustable for optimized focus to take clear pictures of the first and second connectors on the backplane of the rack or chassis.
7. The inspection system of any of clauses 1-6, wherein the first USB optical sensor is configured to perform at least one of a pan operation or a zoom operation to modify the first field of view.
8. The inspection system of any of clauses 1-7, wherein the computing device generates the diagnosis by applying a first machine learning algorithm to the one or more images to identify one or more defective pins included in the first connector.
9. The inspection system of any of clauses 1-8, wherein the computing device generates the diagnosis by applying a first machine learning algorithm to the one or more images to identify at least one foreign object that resides in the first connector.
10. The inspection system of any of clauses 1-9, wherein the computing device is configured to enhance a first region of a first image included in the one or more images that corresponds to a first portion of the first connector.
11. The inspection system of any of clauses 1-10, wherein the inspection tray has a form factor that is physically compatible with the slot of the rack or chassis but would not engage with the first or second connectors on the backplane of the rack or chassis when the inspection tray is inserted into the slot.
12. The inspection system of any of clauses 1-11, wherein the computing device includes one or more memories storing instructions, one or more processors coupled to the one or more memories that, when executing the instructions, generate the diagnosis of the one or more connectivity disruptions associated with the first connector based on the one or more images captured by the first USB optical sensor, and a display device coupled to the computing device, wherein the display device displays the one or more images.
13. The inspection system of any of clauses 1-12, wherein the rack or chassis is configured to interconnect at least two of a plurality of modular compute trays, a plurality of storage trays, or a plurality of networking trays.
14. The inspection system of any of clauses 1-13, wherein the rack or chassis includes the backplane, and wherein the backplane includes the first connector.
15. An inspection tray for diagnosing defective connectors in computer system enclosures, comprising a first optical sensor having a first field of view that includes a first connector on a computer system enclosure when the inspection tray is inserted into a server slot included in the computer system enclosure, wherein the inspection tray has a form factor that is physically compatible with the server slot, and an interface that transmits one or more images captured by the first optical sensor to a computing device that generates a diagnosis of one or more connectivity disruptions associated with the first connector based on the one or more images.
16. The inspection tray of clause 15, further comprising a second optical sensor having a second field of view that includes a second connector on the computer system enclosure when the inspection tray is inserted into the server slot.
17. The inspection tray of any of clauses 15-16, further comprising a hub that couples the first optical sensor to the interface, wherein the hub receives the one or more images from the first optical sensor and transmits the one or more images to the interface.
18. The inspection tray of any of clauses 15-17, wherein the first optical sensor is configured to perform at least one of a pan operation or a zoom operation to modify the first field of view.
19. The inspection tray of any of clauses 15-18, wherein the computing device generates the diagnosis by applying a first machine learning algorithm to the one or more images to identify one or more defective pins included in the first connector.
20. Various embodiments include a computer-implemented method, comprising causing a first optical sensor to capture one or more images of a first connector on a rack, and executing one or more machine learning algorithms based on the one or more images to generate a diagnosis of one or more connectivity disruptions associated with the first connector.
21. A data center, comprising a rack, including a slot that includes a first connector, and an inspection tray that couples to the slot, including a first optical sensor having a first field of view that includes the first connector when the inspection tray is inserted into the slot, and a computing device that couples to the first optical sensor and generates a diagnosis of one or more connectivity disruptions associated with the first connector based on one or more images captured by the first optical sensor.
22. The data center of clause 21, wherein the inspection tray further includes a second optical sensor having a second field of view that includes a second connector on the rack when the inspection tray is inserted into the slot.
23. The data center of any of clauses 21-22, wherein the inspection tray further includes a hub that couples the first optical sensor to the computing device.
24. The data center of any of clauses 21-23, wherein the inspection tray has a form factor that is physically compatible with the slot.
25. The data center of any of clauses 21-24, wherein the inspection tray has a form factor that is substantially similar to a compute tray, a network tray, or a storage tray.
26. The data center of any of clauses 21-25, wherein the computing device includes one or more memories storing instructions, and one or more processors coupled to the one or more memories that, when executing the instructions, generate the diagnosis of the one or more connectivity disruptions associated with the first connector based on the one or more images captured by the first optical sensor.
27. The data center of any of clauses 21-26, wherein the computing device generates the diagnosis by applying a first machine learning algorithm to the one or more images to identify one or more defective pins included in the first connector.
28. The data center of any of clauses 21-27, wherein the computing device generates the diagnosis by applying a first machine learning algorithm to the one or more images to identify at least one foreign object that resides in the first connector.
29. The data center of any of clauses 21-28, further comprising a display device coupled to the computing device, wherein the display device displays the one or more images.
30. The data center of any of clauses 21-29, wherein a modular computer system couples to the rack via the first connector

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. An inspection system, comprising:
an inspection tray that couples to a slot in a rack or chassis, including:
a first universal serial bus (USB) optical sensor having a first field of view that includes a first connector on a backplane of the rack or chassis when the inspection tray is inserted into the slot; and
a computing device that couples to the first USB optical sensor and generates a diagnosis of one or more connectivity disruptions associated with the first connector based on one or more images captured by the first USB optical sensor.

2. The inspection system of claim 1, further comprising a second USB optical sensor having a second field of view that includes a second connector on the backplane of the rack or chassis when the inspection tray is inserted into the slot.

3. The inspection system of claim 2, further comprising one or more USB light-emitting diode (LED) lights, wherein at least one of a position, an orientation, or a brightness associated with the one or more USB LED lights is adjustable to increase an illumination level associated with the first or second connectors on the backplane of the rack or chassis when the inspection tray is inserted into the slot.

4. The inspection system of claim 3, further comprising a USB hub that couples the first USB optical sensor to the computing device, wherein the USB hub receives the one or more images from the first USB optical sensor and transmits the one or more images to the computing device, and wherein the one or more USB LED lights are also attached to the USB hub for power and for brightness control from the computing device.

5. The inspection system of claim 4, wherein the USB hub is also connected to an external power source to provide power to the first USB optical sensor, the second USB optical sensor, and the one or more USB LED lights.

6. The inspection system of claim 2, wherein mounting locations and angles of the first USB optical sensor and the second USB optical sensor are adjustable for optimized focus to take clear pictures of the first and second connectors on the backplane of the rack or chassis.

7. The inspection system of claim 1, wherein the first USB optical sensor is configured to perform at least one of a pan operation or a zoom operation to modify the first field of view.

8. The inspection system of claim 1, wherein the computing device generates the diagnosis by applying a first machine learning algorithm to the one or more images to identify one or more defective pins included in the first connector.

9. The inspection system of claim 1, wherein the computing device generates the diagnosis by applying a first machine learning algorithm to the one or more images to identify at least one foreign object that resides in the first connector.

10. The inspection system of claim 1, wherein the computing device is configured to enhance a first region of a first image included in the one or more images that corresponds to a first portion of the first connector.

11. The inspection system of claim 1, wherein the inspection tray has a form factor that is physically compatible with the slot of the rack or chassis but would not engage with the first or second connectors on the backplane of the rack or chassis when the inspection tray is inserted into the slot.

12. The inspection system of claim 1, wherein the computing device includes:
one or more memories storing instructions;
one or more processors coupled to the one or more memories that, when executing the instructions, generate the diagnosis of the one or more connectivity disruptions associated with the first connector based on the one or more images captured by the first USB optical sensor, and
a display device coupled to the computing device, wherein the display device displays the one or more images.

13. The inspection system of claim 1, wherein the rack or chassis is configured to interconnect at least two of a plurality of modular compute trays, a plurality of storage trays, or a plurality of networking trays.

14. The inspection system of claim 1, wherein the rack or chassis includes the backplane, and wherein the backplane includes the first connector.

15. An inspection tray for diagnosing defective connectors in computer system enclosures, comprising:
a first optical sensor having a first field of view that includes a first connector on a computer system enclosure when the inspection tray is inserted into a server slot included in the computer system enclosure, wherein the inspection tray has a form factor that is physically compatible with the server slot; and
an interface that transmits one or more images captured by the first optical sensor to a computing device that generates a diagnosis of one or more connectivity disruptions associated with the first connector based on the one or more images.

16. The inspection tray of claim 15, further comprising a second optical sensor having a second field of view that includes a second connector on the computer system enclosure when the inspection tray is inserted into the server slot.

17. The inspection tray of claim 15, further comprising a hub that couples the first optical sensor to the interface, wherein the hub receives the one or more images from the first optical sensor and transmits the one or more images to the interface.

18. The inspection tray of claim 15, wherein the first optical sensor is configured to perform at least one of a pan operation or a zoom operation to modify the first field of view.

19. The inspection tray of claim 15, wherein the computing device generates the diagnosis by applying a first machine learning algorithm to the one or more images to identify one or more defective pins included in the first connector.

20. A computer-implemented method, comprising:
causing a first optical sensor to capture one or more images of a first connector on a rack; and
executing one or more machine learning algorithms based on the one or more images to generate a diagnosis of one or more connectivity disruptions associated with the first connector.
